(19) United States
(12) Patent Application Publication
(10) Pub. No.: US 2016/0125513 A1
(43) Pub. Date: May 5, 2016

(54) SYSTEM FOR EXCHANGING GOODS VIA ELECTRONIC DEVICE AND METHOD OF USING THE SAME

(71) Applicant: Matthew Ranauro, Lancaster, PA (US)

(72) Inventor: Matthew Ranauro, Lancaster, PA (US)

(21) Appl. No.: 14/931,686

(22) Filed: Nov. 3, 2015

Related U.S. Application Data
(60) Provisional application No. 62/074,230, filed on Nov. 3, 2014.

(51) Int. Cl. G06Q 30/06; G06Q 20/40

(52) U.S. Cl. CPC G06Q 30/0637; G06Q 20/40

(57) ABSTRACT

The present disclosure relates to systems and methods for classification, viewing, sorting, rating, ranking, listing, selling and acquiring goods in a consumer to consumer marketplace, which provide an individual with the ability to browse goods through a number of different communities, both geographical and otherwise, and further including custom communities. The systems and methods further comprise a unique user storefront, which may further be customized to meet the individual user's needs and wants. The systems and methods described herein further provide a user with the ability to define parameters associated with a particular community, group or subgroup and invite other user to join the community, group or subgroup.

### CROSS-REFERENCE TO RELATED APPLICATIONS

The present application claims priority to U.S. Provisional Patent Application No. 62/074,230 filed Nov. 3, 2014. The provisional application is incorporated by reference herein in its entirety.

### FIELD OF THE INVENTION

The present disclosure relates to the exchange of goods, including but not limited to consumer to consumer exchanges and transactions, via an electronic device. In particular, the present disclosure relates to consumer to consumer transactions that are achieved through use of an electronic device and associated mobile application.

### BACKGROUND OF THE INVENTION

There are presently a limited number of online storefronts for exchange of previously purchased goods, and those storefronts suffer from a number of drawbacks. For example, current storefronts only accept exchange of goods for payment in cash directly between the parties involved in a particular transaction, and do not offer the buyer or seller to use other methods of payment such as credit cards. This can create security issues and personal safety issues when meeting a potential buyer with the good(s) in question, and for the potential buyer who arrives with cash for the purchase but has never met the seller prior to the transaction.

As another example, in order for the seller to accept the goods, he or she has to physically drive to the location of the goods and potentially borrow or rent a larger vehicle for moving the goods. This creates additional problems when the goods are only available for a limited time (i.e., during a moving or garage sale) or when the goods are a great distance from the buyer. Furthermore, certain goods can only be verified as being in a working condition when the buyer returns to their own home (such as a television or other electronic device), and therefore the buyer needs to have the ability to return the merchandise in the event that the goods are damaged or not working properly.

Additionally, the size of most metropolitan communities has grown to exceed 1,000,000 individual online consumers. The inability to sort and find certain types of goods quickly and efficiently is currently lacking in existing storefronts. For instance, certain online storefronts are comprised of hundreds of items all grouped together on a single list, and are not easily searched using the storefront application provided. This problem multiplies when the size of the consuming population increases. Furthermore, the current models used for purchasing classified goods is limited to cash transactions, involves significant time to complete the transaction, includes little to no customer service and is in many respects unsafe to the consumer.

### SUMMARY OF THE INVENTION

The present disclosure solves these and other problems, and is described in detail below.

In a typical transaction, there is a buyer, a seller, and a platform for purchasing at least one type of good via the application. The transaction may be processed in a known manner, such as via debit card, a PayPal account, a credit card, or other forms of payment as discussed above. Transactions are set up in a similar manner as transactions made via the application known as Cragislist, although the level of security and efficiency with which the transaction is completed are greatly improved.

One novel aspect of the present disclosure is the ability to permit payment to be offered and then accepted based on proximity of the user to the goods and/or completion of the transaction to both parties' satisfaction. For example, the present disclosure may provide the seller with the ability to place the good in a safe location, prearranged by the parties, and then indicate that the good is ready to be received by the buyer. That notification may come in a variety of forms, but in one embodiment is provided over a mobile device messaging service.

Next, the buyer may consciously or automatically send a separate message once the buyer is in proximity to the good. Then, the buyer can inspect the good and make acquire the good, which then accepts the sellers offer to accept the good. Payment may be made by cash, credit card, paypal, Apple Pay, proximity pay, bitcoin, and other forms of online currency. The transaction may be completed at this stage, or alternatively may be completed once the buyer is able to verify the good is in working condition once he or she returns to their home. After the transaction is complete, both the seller and the buyer receive a virtual receipt on their transaction.

In addition, the disclosure provides the users with the ability to rate the user or the good, rate the transaction or the safe drop zone, and place the transaction into the parties' order history. The safe zone may be a prearranged location agreed to between the parties or may be a location offered by the service associated with the mobile storefront, depending on the location and the availability of such locations within a community.

The present disclosure also solves the problems with the prior art by providing the service of pick-up and delivery to the users. In one embodiment, the delivery is made through use of a vehicle that is pre-arranged by the service provider and insured by the operator of the storefront. In another embodiment, the vehicle used for the delivery service is a driver who owns their own vehicle and is willing to accept a fee for providing this service (i.e., Uber). In this embodiment, the exchange of potential goods in a transaction may be selected by the driver from the mobile storefront, and may be identified based on proximity to the driver and/or the nature of the good to be transported. Each driver will preferably be prescreened prior to authorization to accept delivery of goods through the mobile storefront to ensure security and safety.

Next, the present disclosure provides a wide variety of benefits over the prior art with respect to classification of goods and the ability to browse goods through a number of different communities. For example, if a user wants to create a group, such as a buy/sell/trade group, the user has the ability to define the parameters of that group through the mobile storefront and make that community visible to select users (i.e., by proximity or by password) or generally accessible to any user of the mobile storefront. The user-defined community may be the user's neighborhood or school, for example.

The mobile application also permits a user to shop within a certain larger geographical community and set the parameters of their search by community (as opposed to simply a number of miles away from the user). And in other embodiment, the mobile application includes communities having a particular product or other interest, whereby the goods within that community are focused. For example, if the user is really interested in musical equipment, the user may also create a community specific to that interest (i.e., Reddit).

Another benefit that the present disclosure provides over other mobile storefronts is the ability to connect with a service provider who may provide customer service to the potential buyer or seller (i.e., the listing is not purely anonymously operated and the user may contact the operator of the mobile storefront for assistance). These benefits and other benefits will become better appreciated after reading the detailed disclosure and appendices hereto.

The Summary of the Invention is neither intended nor should it be construed as being representative of the full extent and scope of the present disclosure. The present disclosure is set forth in various levels of detail in the Detailed Description, and no limitation as to the scope of the present disclosure is intended by either the inclusion or non-inclusion of elements, components, etc. in this Summary of the Invention. Additional aspects of the present disclosure will become more readily apparent from the Detailed Description, particularly when read together with the Claims.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below.

### BRIEF DESCRIPTION OF THE DRAWINGS

FIG. 1 is a plan view of an application display according to one particular embodiment;

FIG. 2 is another plan view of an application display according to one particular embodiment;

FIG. 3 is another plan view of an application display according to one particular embodiment;

FIG. 4 is another plan view of an application display according to one particular embodiment;

FIG. 5 is another plan view of an application display according to one particular embodiment;

FIG. 6 is another plan view of an application display according to one particular embodiment;

FIG. 7 is another plan view of an application display according to one particular embodiment;

FIG. 8 is another plan view of an application display according to one particular embodiment;

FIG. 9 is another plan view of an application display according to one particular embodiment;

FIG. 10 is another plan view of an application display according to one particular embodiment;

FIG. 11 is another plan view of an application display according to one particular embodiment;

FIG. 12 is another plan view of an application display according to one particular embodiment;

FIG. 13A-C are additional plan views of an application display according to one particular embodiment;

FIG. 14 is another plan view of an application display according to one particular embodiment;

FIG. 15 is another plan view of an application display according to one particular embodiment;

FIG. 16A-D are additional plan views of an application display according to one particular embodiment;

FIG. 17A-B are additional plan views of an application display according to one particular embodiment;

FIG. 18A-D are additional plan views of an application display according to one particular embodiment; and

FIG. 19A-C are additional plan views of an application display according to one particular embodiment.

### DETAILED DESCRIPTION

According to varying embodiments described herein, the present disclosure comprises systems and methods for classification, viewing, sorting, rating, ranking, listing, selling and acquiring goods in a consumer to consumer marketplace. The systems and methods described herein provide an individual with the ability to browse goods through a number of different communities, both geographical and otherwise, and further including custom communities, groups and subgroups. The systems and methods further comprise a unique user storefront, which may further be customized to meet the individual user's needs and wants, yet may also be distributed to other individuals associated with a particular community, group or subgroup. The systems and methods described herein further provide a user with the ability to define parameters associated with a particular community, group or subgroup and invite other user to join the community, group or subgroup. In alternative embodiments, the community, group or subgroup is open to a larger class of users (i.e., by proximity) or may be restricted to a certain invited class of users (i.e., by password), or may be generally accessible to any user. By way of example but not limitation, a user-defined community may be the user's county, city, neighborhood or school.

According to varying embodiments described herein, the systems and methods of the present disclosure allow a user to shop within a certain geographical community and, if the user so desires, establish parameters for any good or service the particular user is interested in. For example, a user may set a parameter for searching for a certain type of good or service within a particular community (as opposed to searching for goods or services a set distance away from the users current location). “Communities” or “groups” or “subgroups” may include communities having a particular product or service-related interest or other interest, whereby the dialog within that community are uniquely focused. For example, certain communities may be focused on musical equipment. A user may create a customized community specific to his or her interests.

In a preferred embodiment, the electronic device further comprises an application, whereby the application provides an individual user with access to at least one marketplace, and further provides an individual user with the ability to create, post, publish, display and view classified or other forms of “advertisements” for various goods. In a preferred embodiment, the application facilitates transactions from one individual consumer to at least one other individual consumer via use of the application. The application also comprises a number of other features to enhance the transaction experience, as described herein. The mobile application according to this embodiment may be referred to as “Dibs” or “Dibs List.”

According to varying embodiments, the systems and methods described herein may further facilitate delivery and exchange of goods or services purchased or sold via the application. In a preferred embodiment, the application provides the option of having the good or service delivered by a pre-arranged provider, and also provides the option of selecting a safe drop zone for picking up the good or service purchased by the user. The safe drop zone may be a location that is convenient to a majority of the users within a particular community, group or subgroup, and may also facilitate inspection and testing of the good or service prior to authorizing the transaction and exchange from the seller to the buyer. The safe zone may be a prearranged location agreed to between the parties, or may be a location offered by the service associated with the application, depending on the location and the availability of such locations within a community.

In one embodiment, the user selects delivery of the good or service through use of a vehicle that is pre-arranged by the service provider. In another embodiment, the vehicle used for the delivery service is a driver who owns their own vehicle and is willing to accept a fee for providing this service (i.e., a service akin to Uber). In this embodiment, the exchange of potential goods in a transaction may be selected by the driver via the application, and may be identified based on proximity to the driver and/or the nature of the good to be transported. Each driver will preferably be prescreened prior to authorization to accept delivery of goods through the mobile storefront to ensure security and safety. In another embodiment, the application identifies vehicles that are available for temporary use by the purchaser or the seller of a good to use in completing the exchange of the item.

The systems and methods described herein preferably permit payment to be offered, and then accepted, based on proximity of the user to the goods and/or completion of the transaction to both parties' satisfaction. For example, the present disclosure may provide the seller with the ability to place the good in a safe location, prearranged by the parties, and then indicate that the good is ready to be received by the buyer. This is particularly beneficial when the good is an item that requires electrical power to test its usefulness, or where the user contemplating purchase of the good is concerned about his or her personal safety when completing the transaction. By way of further example, but not limitation, the buyer may consciously or automatically send a separate message once the buyer is in proximity to the good. Then, the buyer can inspect the good and if satisfied acquire the good, which then accepts the sellers offer to acquire the inspected item. The transaction may be completed at this stage, or alternatively may be completed once the buyer is able to verify the good is in working condition once he or she returns to their home. After the transaction is complete, both the seller and the buyer receive a receipt on their transaction.

The application according to a preferred embodiment accepts several formats of payment, including but not limited to cash, credit card, paypal, Apple Pay, proximity pay, bitcoin, and other forms of online currency. In preferred embodiments, the application further provides the users with the ability to rate the user or the good, rate the transaction or the safe drop zone, and place the transaction into the parties' order history.

Reference being made to the appended drawing figures, the application described herein provides several benefits to a prospective buyer. From the perspective of the buyer, one objective of the application is the ability to improve browsing and categorizing of local classified or other advertisements for a variety of different goods within a number of communities. In one embodiment, this portion of the application is referred to as “the storefront.” The interface between the buyer and the application is preferably customizable and tailored by the buyer to allow the buyer to easily browse the goods that he or she is interested in acquiring. Examples of categories available on the storefront may comprise communities, groups or subgroups, including by way of example: hobbyists, collectors, automotive, entertainment, musical instruments, sporting goods, authors/readers, students, parents, teachers, artists, retirees, etc. Different geographical communities may be selected as well, further enhancing the browsing experience and/or narrowing the field of search in a manner that has not previously been provided.

In a preferred embodiment, the application is downloaded to an electronic device via a network connection. The application resides in the memory of the electronic device, and further permits any customization or tailoring made by the particular buyer to be retained. The application does not require a buyer to create an account when they install the application, and a new buyer may browse the application “storefront” without restriction.

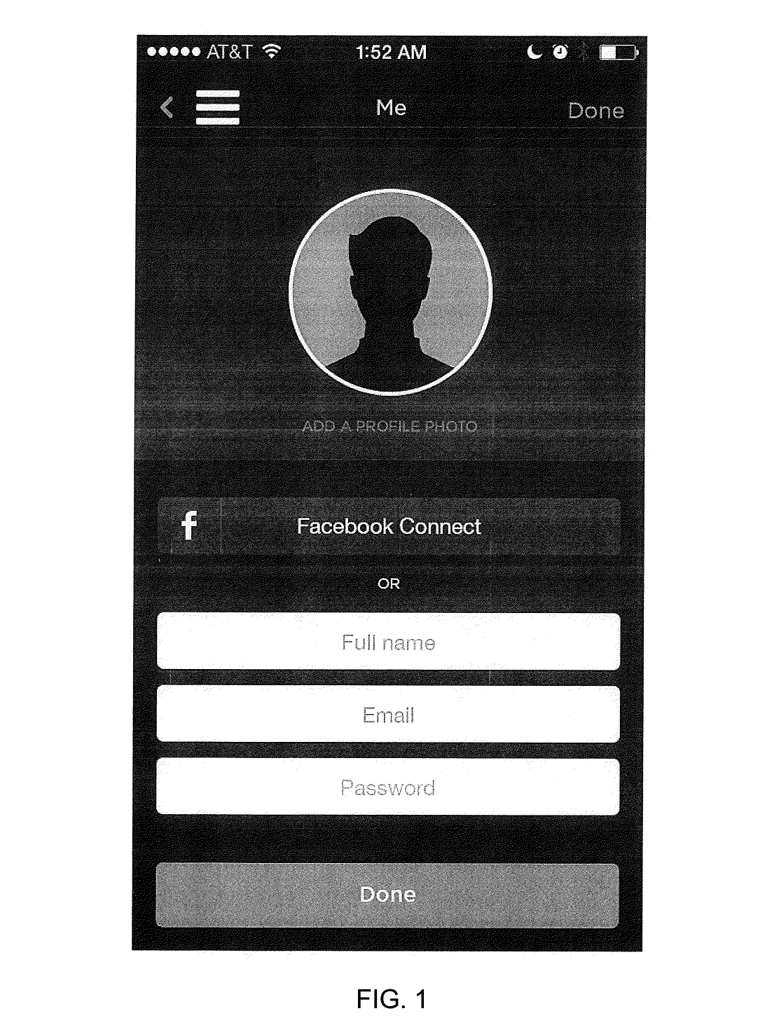

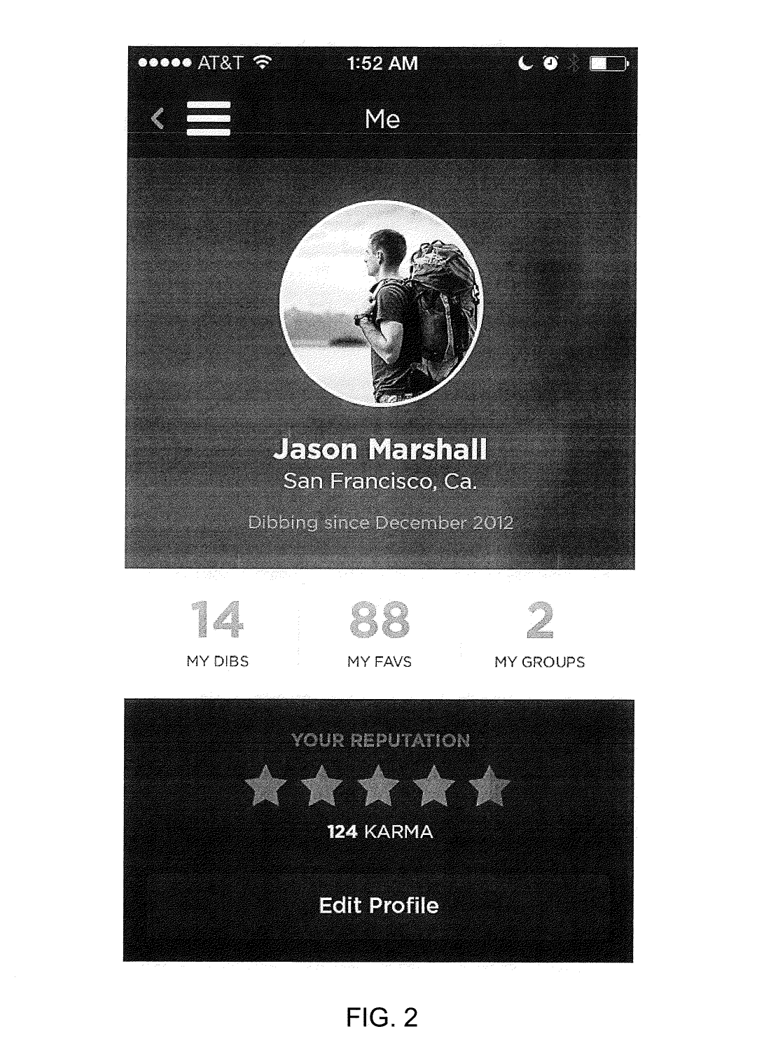

Referring in detail to FIGS. 1 and 2, the application of a preferred embodiment allows a user to create a new profile and establish user-related data associated with the individual. Although the user may remain anonymous, associating the user's transaction and rating history with the user's profile may result in additional benefits as described above. Referring to FIG. 1, the user in a preferred embodiment is directed to upload a photograph or other image, and establish secure credentials for login to the application, such as a user-specific name, email account and/or password. A completed profile may be displayed for any user who completes the profile process described above, and in a preferred embodiment the user profile may display information such as depicted in FIG. 2. The profile in a preferred embodiment includes a dashboard of information that the user may wish to access quickly, including “My Dibs”, “My Fays” and “My Groups.” Additional information such as the user's reputation or ranking may also be displayed on the user's profile.

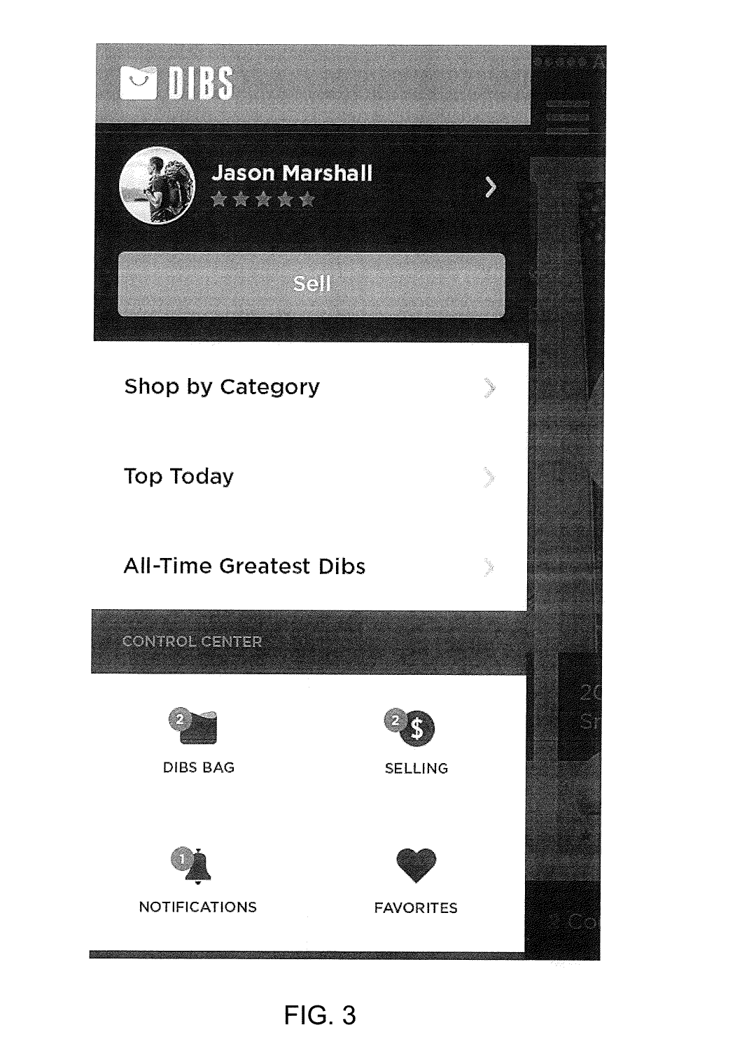

Referring now to FIG. 3, the application in a preferred embodiment may comprise one or more menus. The main menu of a preferred embodiment includes icons or buttons for the user to select one of several functions provided within the application, such as “shop by category” “top today” and “all-time greatest dibs.” A particular user may also have additional menu selections to choose from, such as a button to “sell” a new item through the application. Other icons or buttons may be customized by the user, or may be standard icons or buttons, such as a checkout or “Dibs Bag” icon, a “Notifications” icon, and a “Favorites” icon. The main menu may further comprise a pull down menu or provide access to the applications' settings or control center.

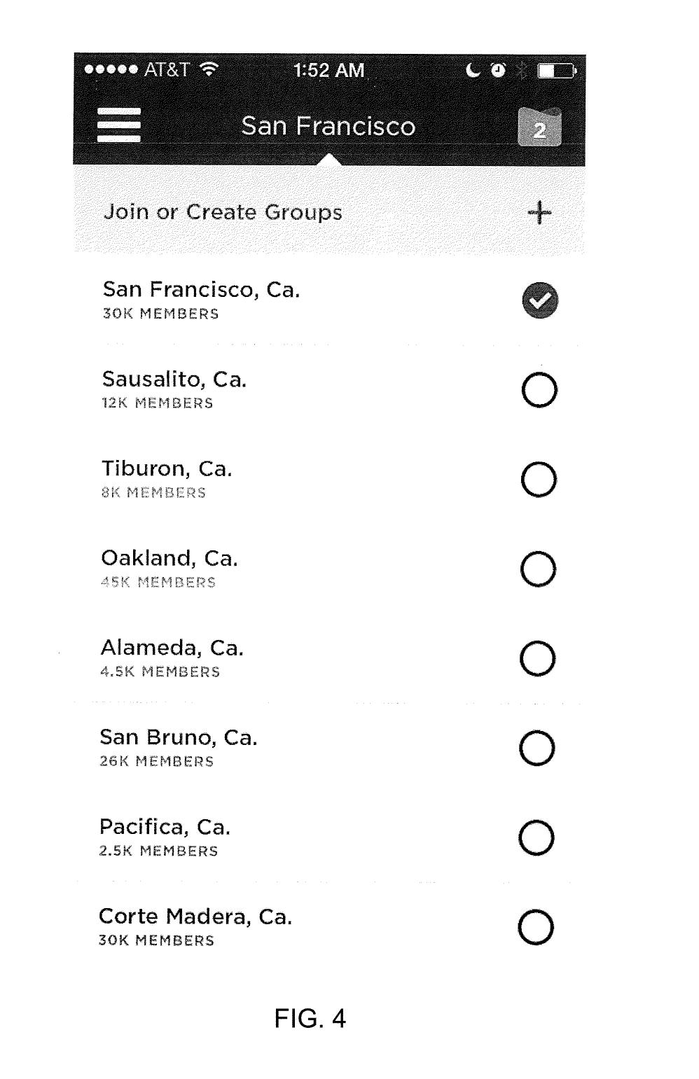

Referring now to FIG. 4, a user may also be directed to select one or more communities, groups or subgroups to affiliate with or follow through the application. The user may select more than one such community, group or subgroup, and may alternatively create a community, group or subgroup. Examples of communities, groups or subgroups may be defined by interest, such as: hobbyists, collectors, automotive, entertainment, musical instruments, sporting goods, authors/readers, students, parents, teachers, artists, retirees, etc. Different geographical communities may be selected or defined as well. In a preferred embodiment, the number of other users associated with a particular community, group or subgroup may be displayed with the location or name of the community, group or subgroup, as shown in FIG. 4.

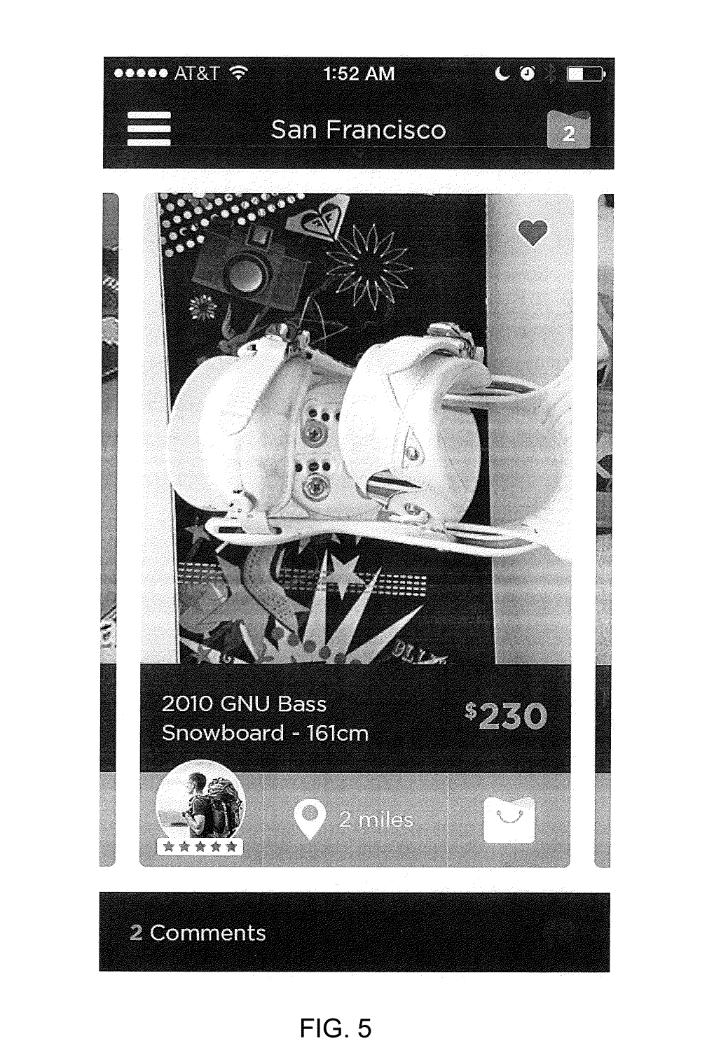

Referring now to FIG. 5, a primary aspect of the application, according to a preferred embodiment, is to provide a user with the ability to quickly and efficiently search for, browse, research and evaluate different “goods” via the application. One embodiment of the present disclosure comprises a “product feed” display, whereby products of a certain type, characteristic, quality, location, venue, nature, etc. may be displayed to the user via the application. In FIG. 5, the product feed includes photographs or other images of a particular good, and the user may quickly navigate from one such good to the next. The product feed may be associated with a particular community, group or subgroup, such as “San Francisco” as seen in FIG. 5. In other embodiments, the product feed may be across multiple communities, groups or subgroups. The basic information preferably included with the product feed would comprise: the name of the good; a brief description of the good; a photograph or other image of the good; the price of the good; and the location of the good (i.e., the city where it is being stored).

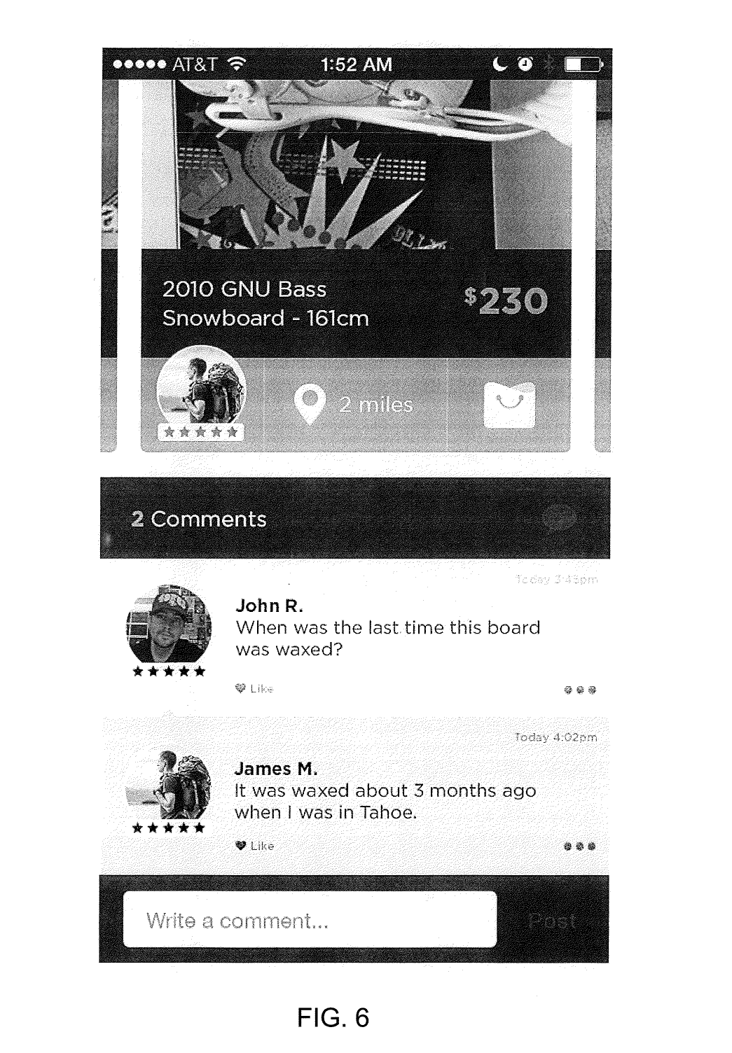

Referring to FIG. 6, the product feed for a particular good may further comprise comments from other users or from the seller of the good. In a preferred embodiment, the most recent comments are displayed, as is a field for the current user to add a comment. In other embodiments, the most relevant comments are listed first. The user may select the ranking system for comments through settings made with the application, if desired.

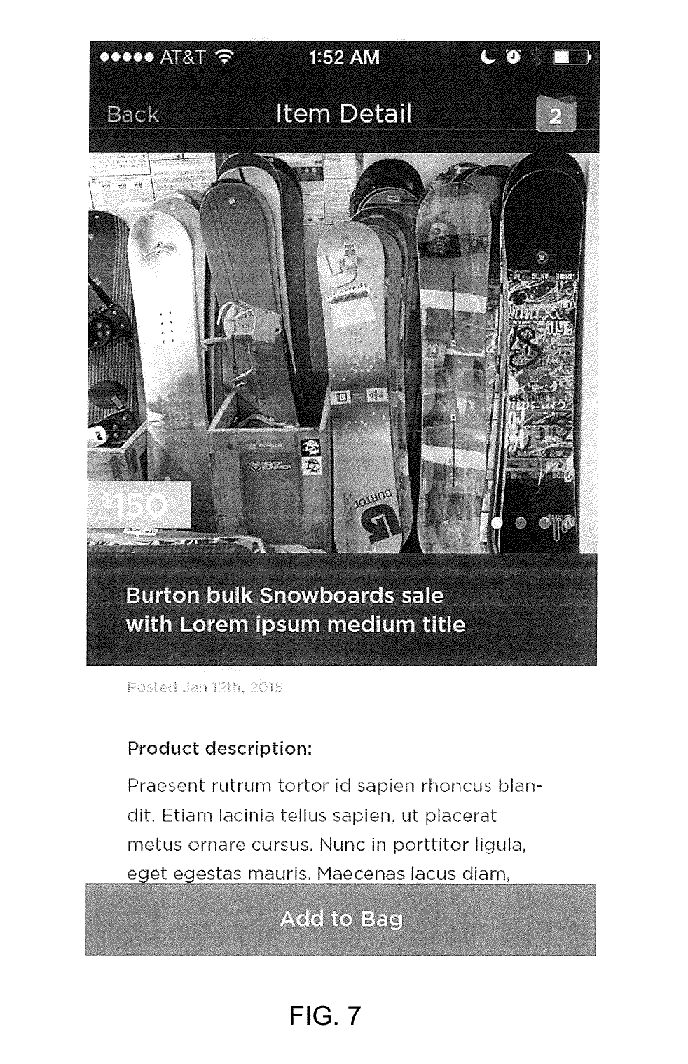

Referring now to FIG. 7, the user may further have the ability to select a good from the product feed display and thereby call up more specific information about the good, which is reflected in FIG. 7 as the “Item Detail.” The item detail display may comprise more information, in the form of photographs, images, text, specifications, drawings, dimensions, etc. relating to the item being offered for sale. The item detail display may further comprise the ability for a user to add the item to the Dibs Bag, which is described both above and below.

If a user who is using the application as a potential buyer wants to make a purchase, and has not yet created a profile, the application prompts the buyer to create a profile and thereby an account. If a profile is already established, the user can immediately add any item or good to the user's Dibs Bag, or the user's “Favorites.” If the user wishes to check out, any available form of payment associated with the user's profile may be applied to the transaction.

Over time and with multiple transactions, a buyer may develop a reputation or ranking within the application. The ranking will inform other users how reliable a particular buyer is when using the application (i.e., how they tend to complete or not complete a transaction). The ranking system contained in the application may be based in part on any positive, neutral or negative input received for a particular buyer. The ranking preferably allows a seller to differentiate between great, average, below average and poor buyers, and differentiate among potential and previous buying and selling experiences.

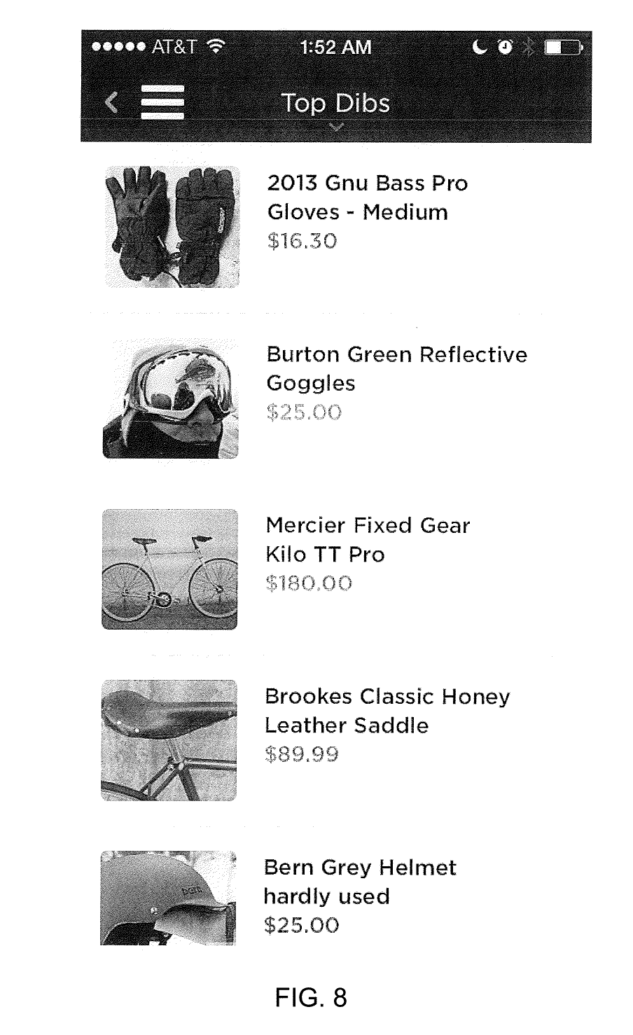

Referring to FIG. 8, the user may be directed to a particular relevant listing based on the user's past transactional history. In one embodiment, this listing is referred to as “Top Dibs.” In one embodiment, the application pushes items or goods into the user's “Top Dibs” listing, which the user may view by selecting from the appropriate menu. The user may further customize the inclusion (or exclusion) of certain items or their nature by making changes to the application's settings.

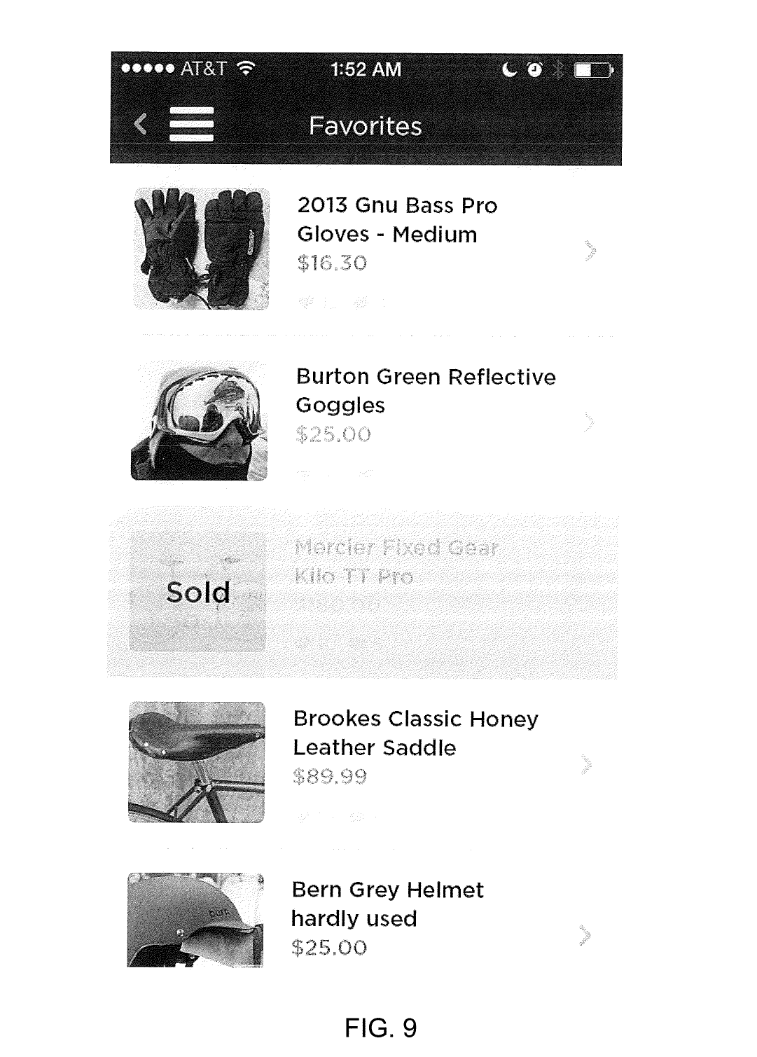

In another embodiment, the application further comprises a search function, which allows a buyer to search for an item without selecting a category. In a preferred embodiment, the application integrates the idea of a shopping cart and/or a “Favorites” list, where a user may save an item for later. By saving an item, the user may consider other purchases before initiating a transaction, or may permit the buyer to consider making an offer on an item based on similar items offered for sale via the application or via other storefronts. A “Favorites” listing according to one embodiment is shown in FIG. 9. According to one embodiment, an item or good once sold changes in appearance to alert the user that an item, while saved to the “Favorites” listing, is no longer available for purchase as shown in FIG. 9.

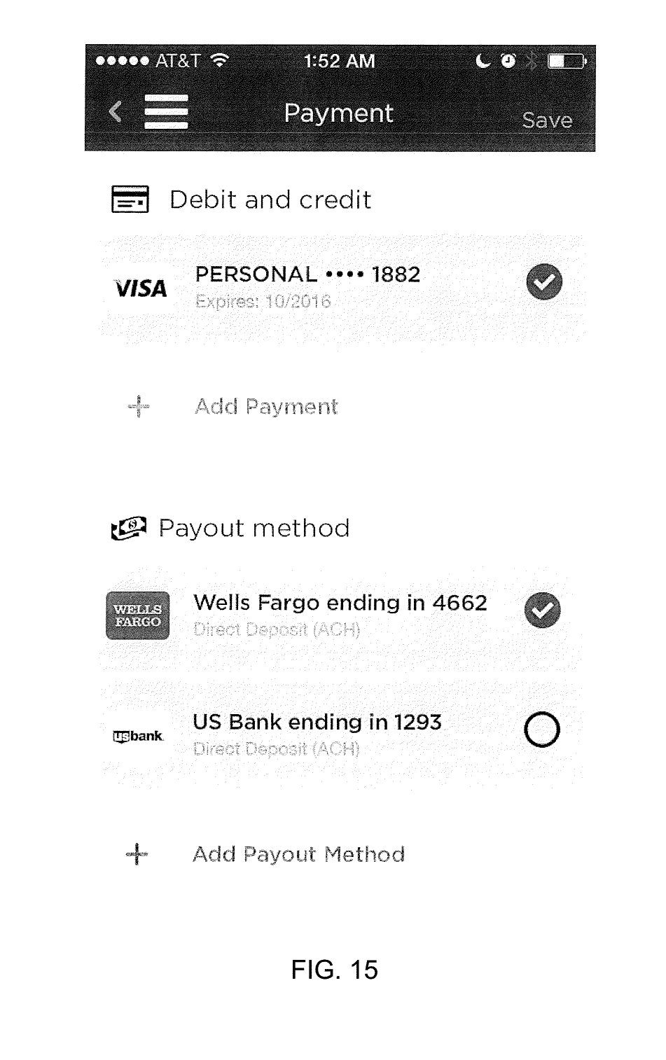

In one embodiment, the application permits a buyer to offer a bid price for a particular item or group of items. The buyer may offer the full asking price for an item, or may offer an amount less than the full asking price of the item. When a price has been offered, it is transmitted to the seller of the item(s). If the offer is accepted, the acceptance is transmitted back to the buyer and a transaction may take place. A payment dialog display according to a preferred embodiment is shown in FIG. 15, and may include several pre-authorized forms of payment.

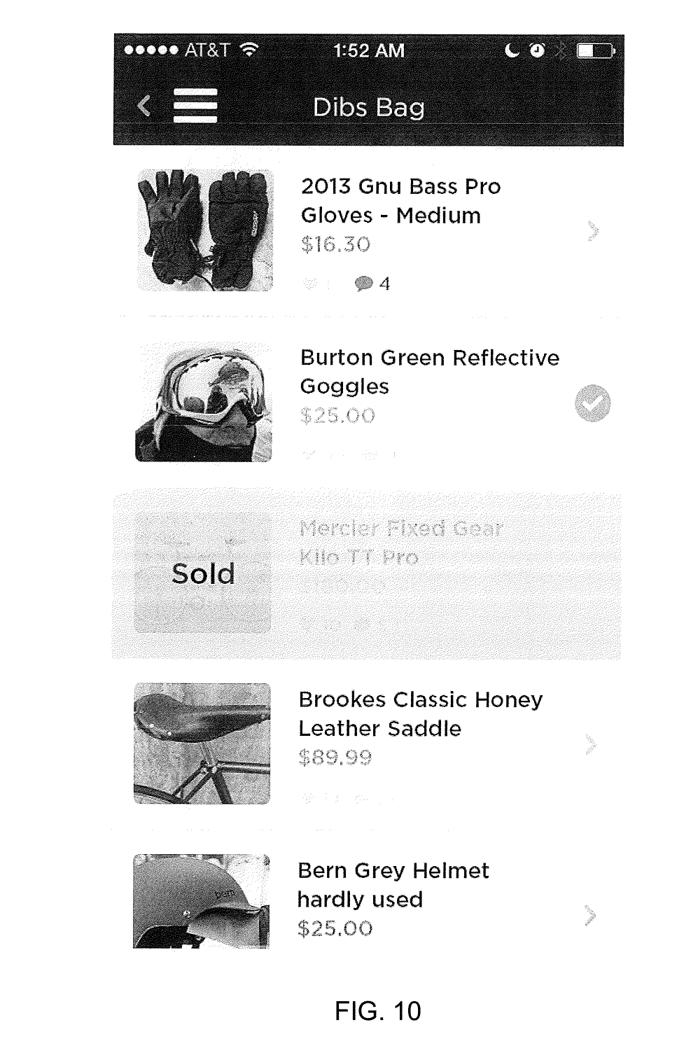

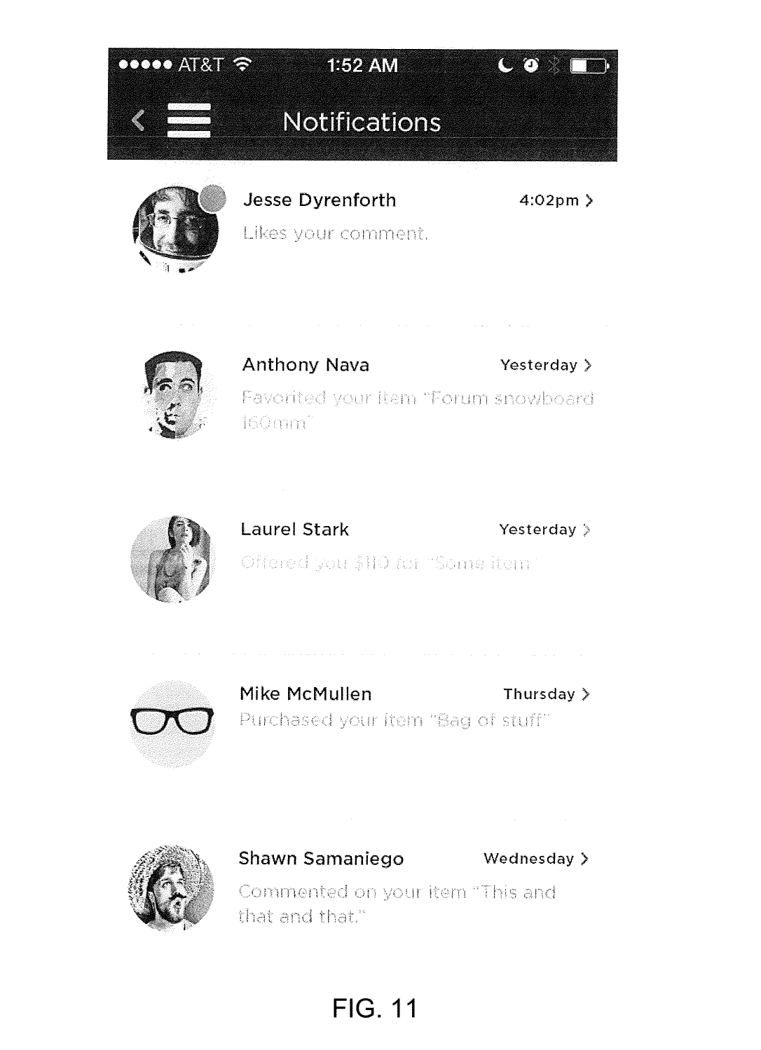

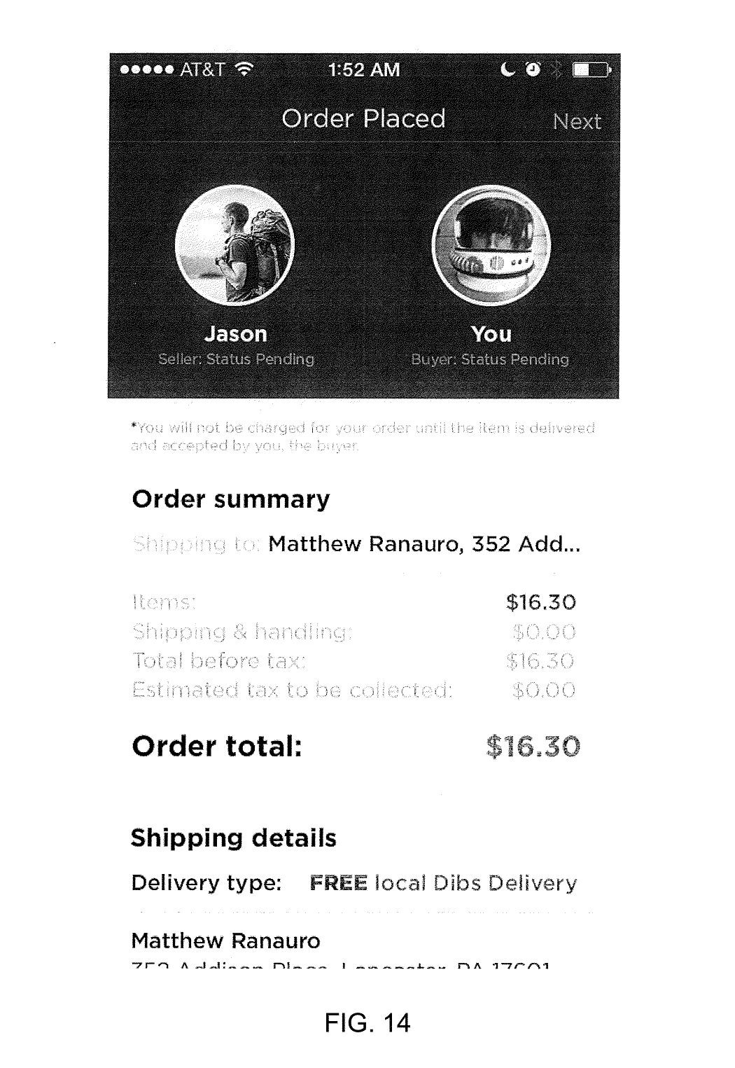

In another embodiment, the user selects one or more goods and those goods are placed in a shopping cart or “Dibs Bag” as shown in FIG. 10. These items are not immediately transacted for purchase, but alert the seller that the user who selected them is contemplating a purchase. In order to complete the purchase, the user may select one or more of the goods in the “Dibs Bag” by selecting an icon, which is shown in FIG. 10 as a check mark. The user will then be prompted to complete the transaction and “check out” via the application. The user may also be prompted with “Notifications” as shown in FIG. 11, and may be notified that a particular good or item is in the user's “Dibs Bag” and not yet purchased. Once the order is placed, the user preferably receives an order confirmation, which may appear in the application as shown in FIG. 14.

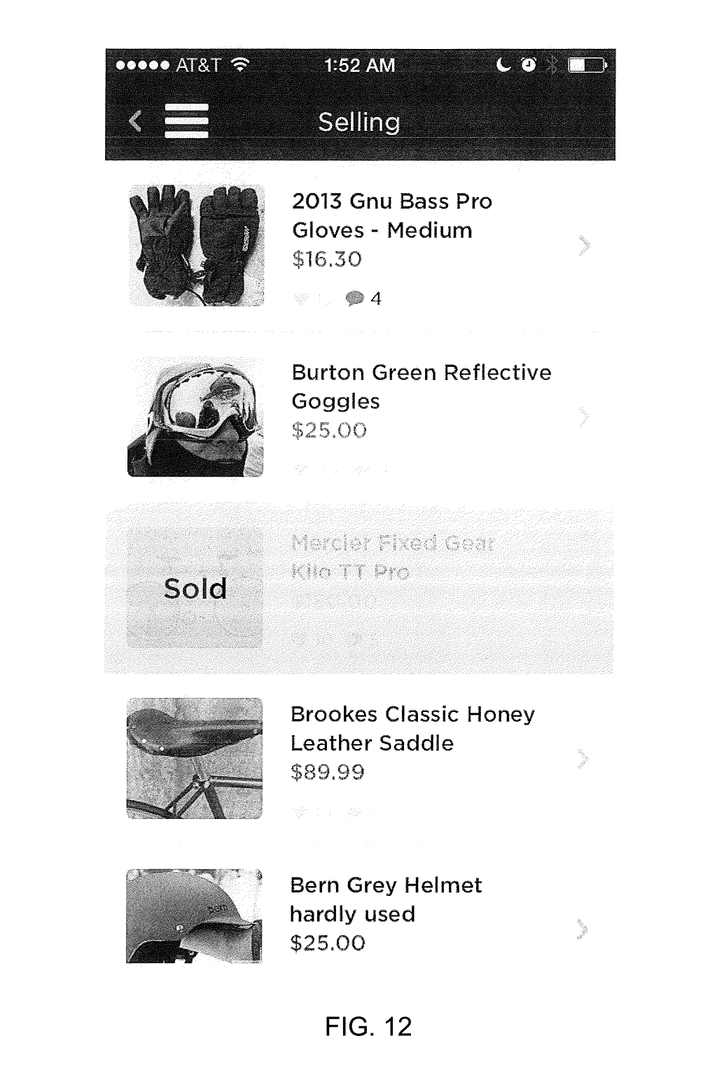

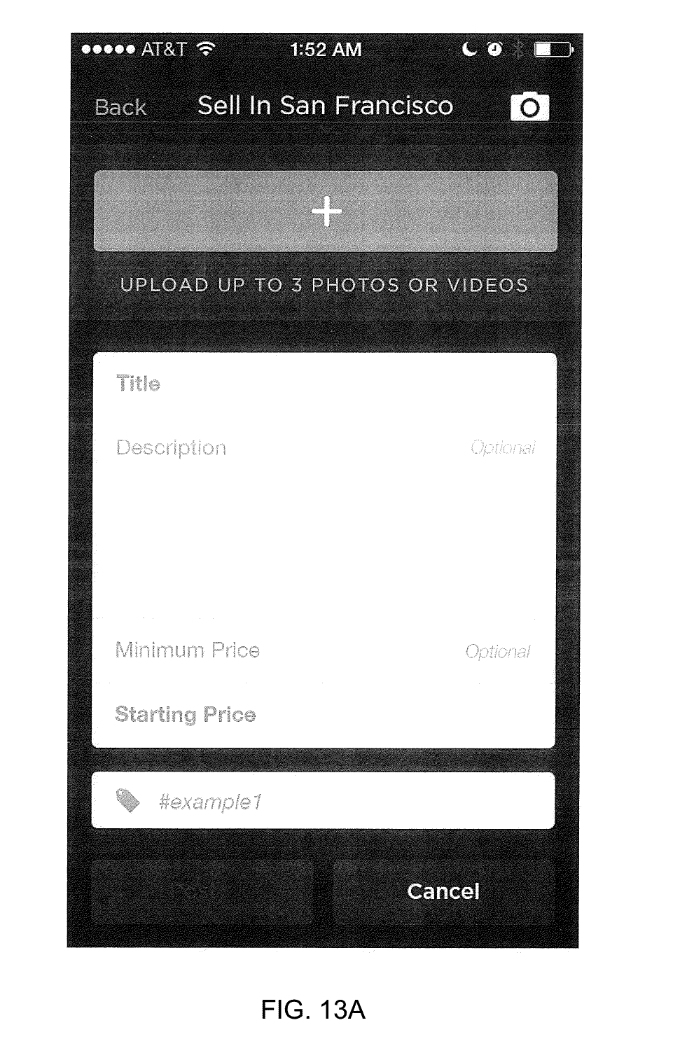

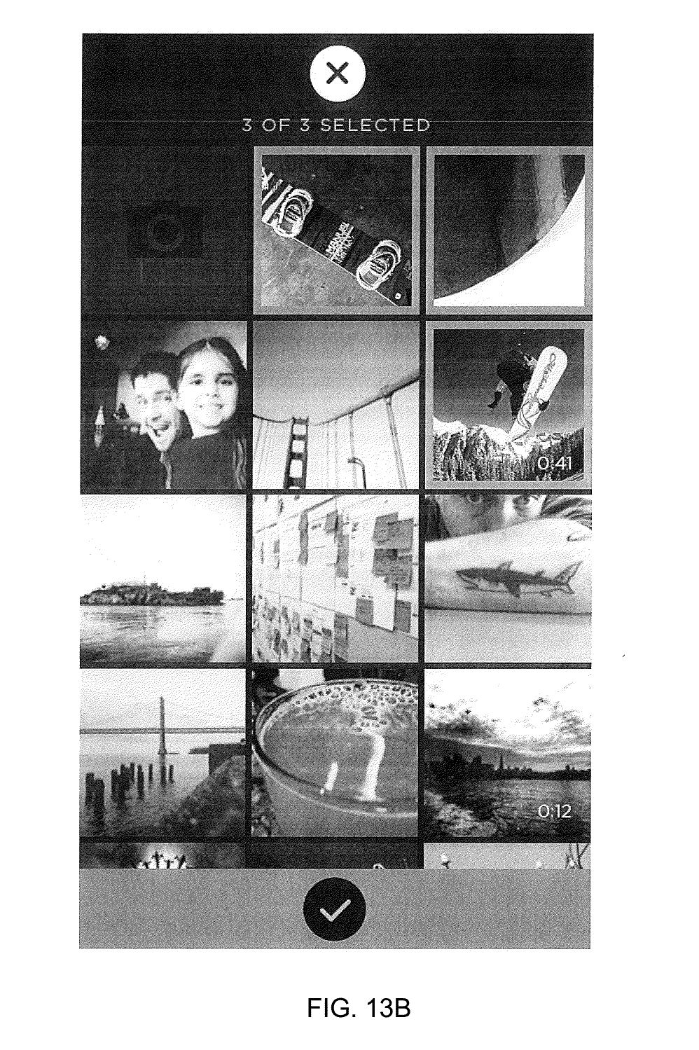

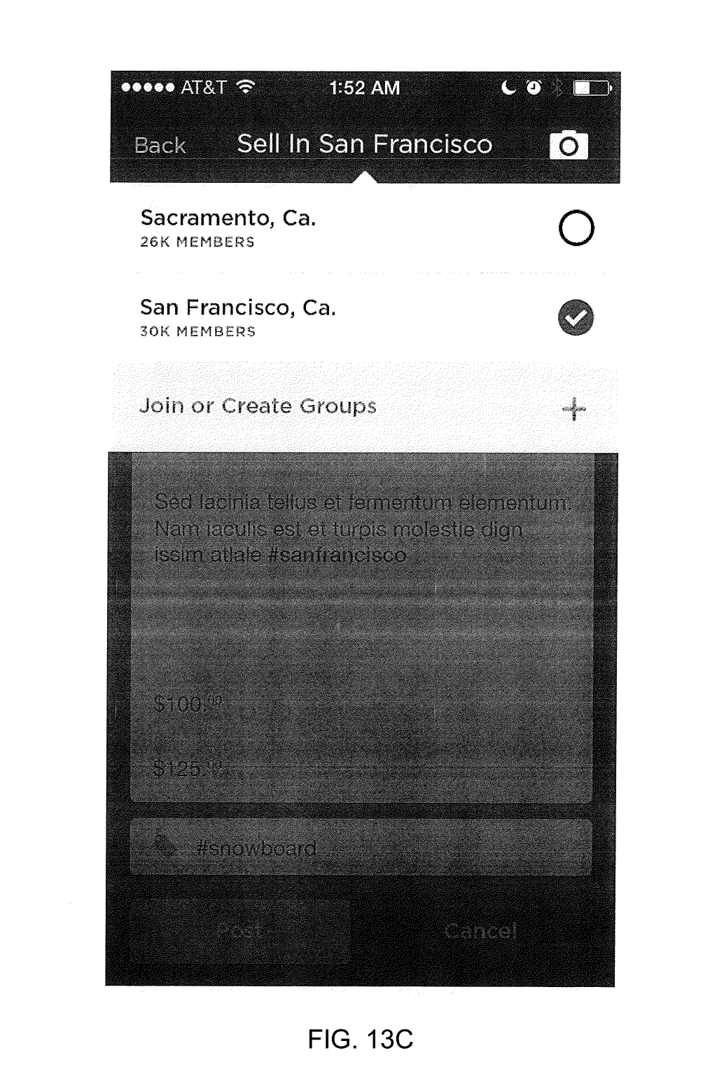

Referring to FIGS. 12 and 13A-C, a user may also sell an item through the application. The items that a user has listed for selling to another user may be conveniently displayed on a single page, as shown in FIG. 12. Referring to FIG. 13A, the user may be prompted to upload information relating to an item to be sold, such as through the display shown in FIG. 13A. The user may select a photograph or other image from stock images available through the application (see FIG. 13B) or may take their own photograph of the item, or alternatively use a different image for the listing. The user may also be prompted to select a community, group or subgroup for listing the good, as shown in FIG. 13C. The user may also select multiple communities if desired. The application may also prompt the user to list a set price, or an unpublished minimum and maximum sell price for the good in question. Once completed, the user may post or publish.

In a preferred embodiment, a transaction occurs via messaging provided by the application. For example, if a buyer makes an offer on an item, the seller receives a notification through the messaging system, they can accept the offer, reject it, counteroffer. From there, the messaging platform handles the steps to complete the transaction.

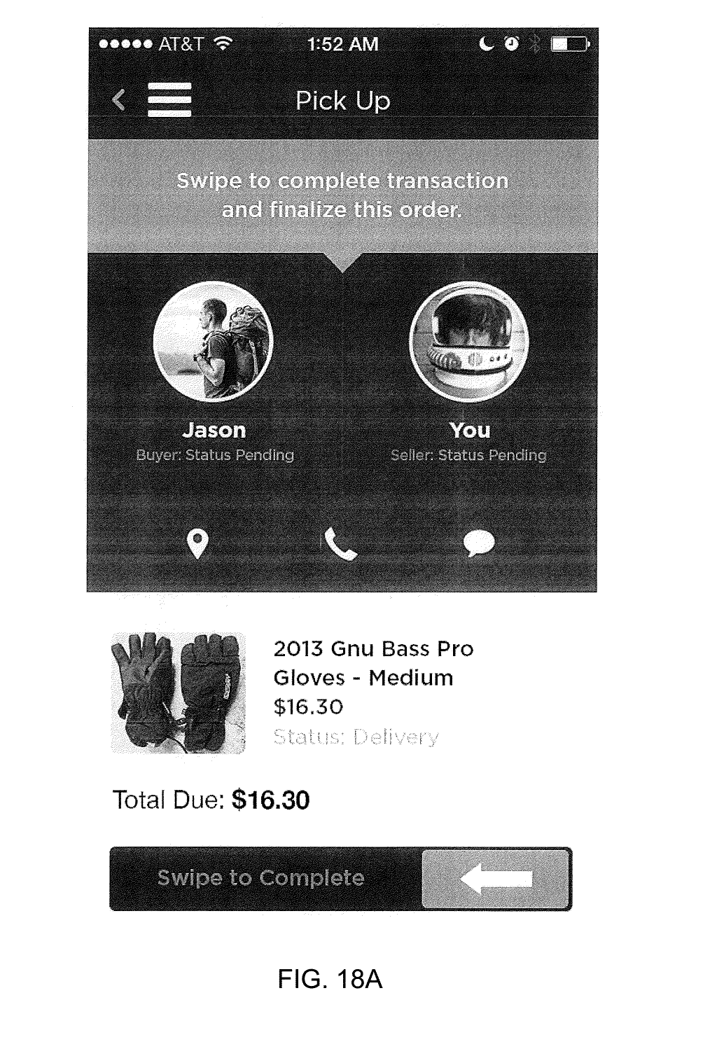

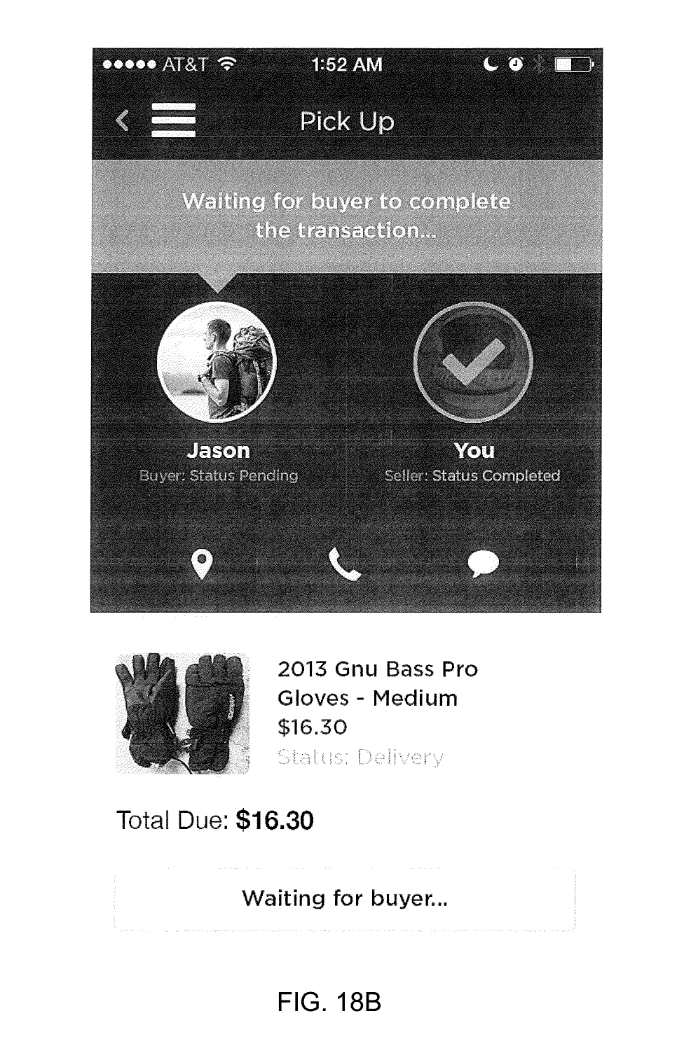

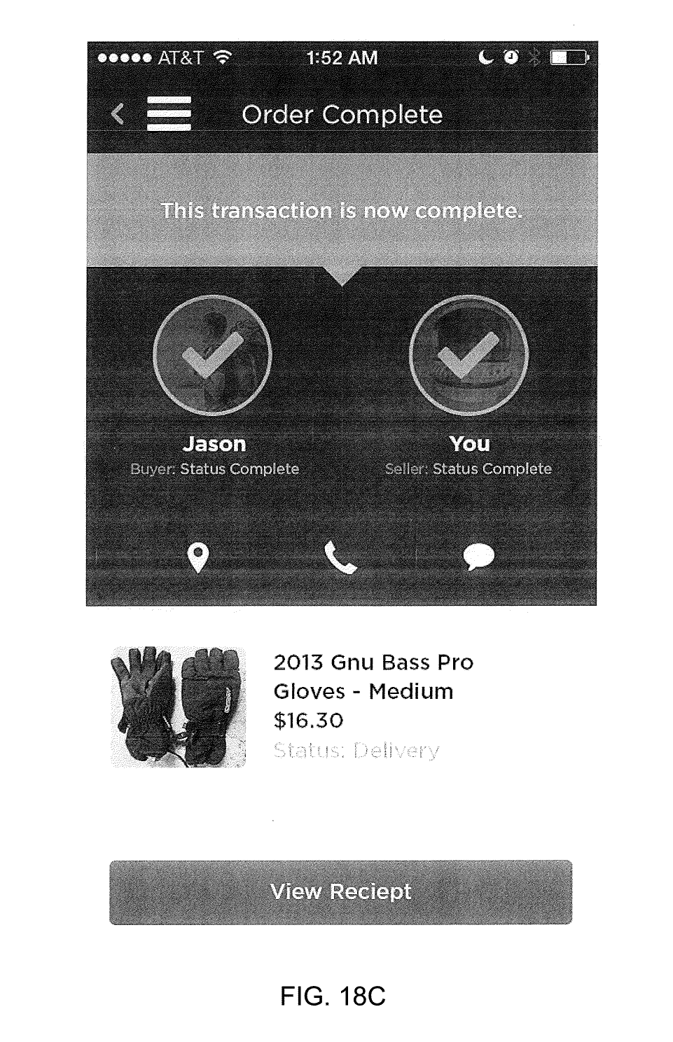

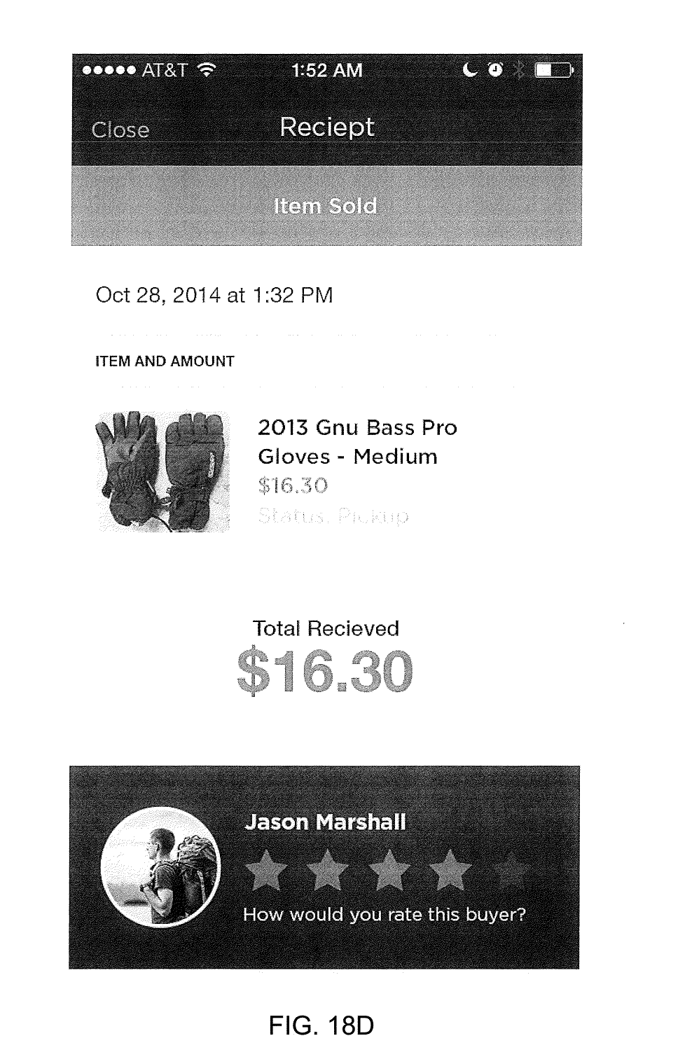

Once the transaction is complete, either the buyer or the seller can select a location to pick-up the item. The location may be at the seller's house, a place of business, a public place, an established marketplace for exchange of goods (i.e., community center, public market, etc.), or it can be at a designated drop location. In one embodiment, the designated drop location is known as a “Dibs Drop.” The Dibs Drop is either an owned or leased location, local to the community of the buyer/seller, where a seller can either drop an item off to be picked-up, or could have the item picked-up from their location to the Dibs Drop. Referring now to FIGS. 18A-D, the user may be prompted through a series of displays offered via the application to complete the transaction using a Dibs Drop. In FIG. 18A, the user is prompted to finalize the order between the buyer and the seller (the user). The item being sold is displayed, as is the price, on the application display. In FIG. 18B, the application informs the user that the buyer is informed of the transaction, and the application is awaiting the inspection and approval of the buyer. Once the buyer inspects the item, if satisfactory, the buyer may complete the transaction by issuing payment and taking ownership of the item. The application then informs the user of this step in the process, as shown in FIG. 18C. A receipt may be included to both seller and buyer, as shown in FIG. 18D.

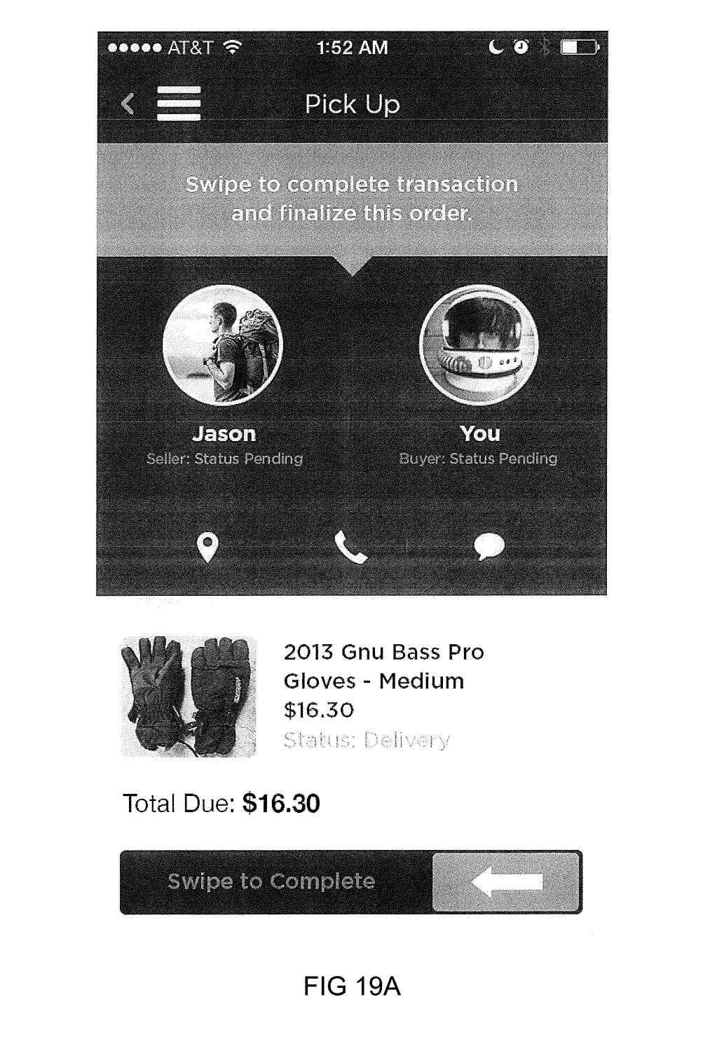

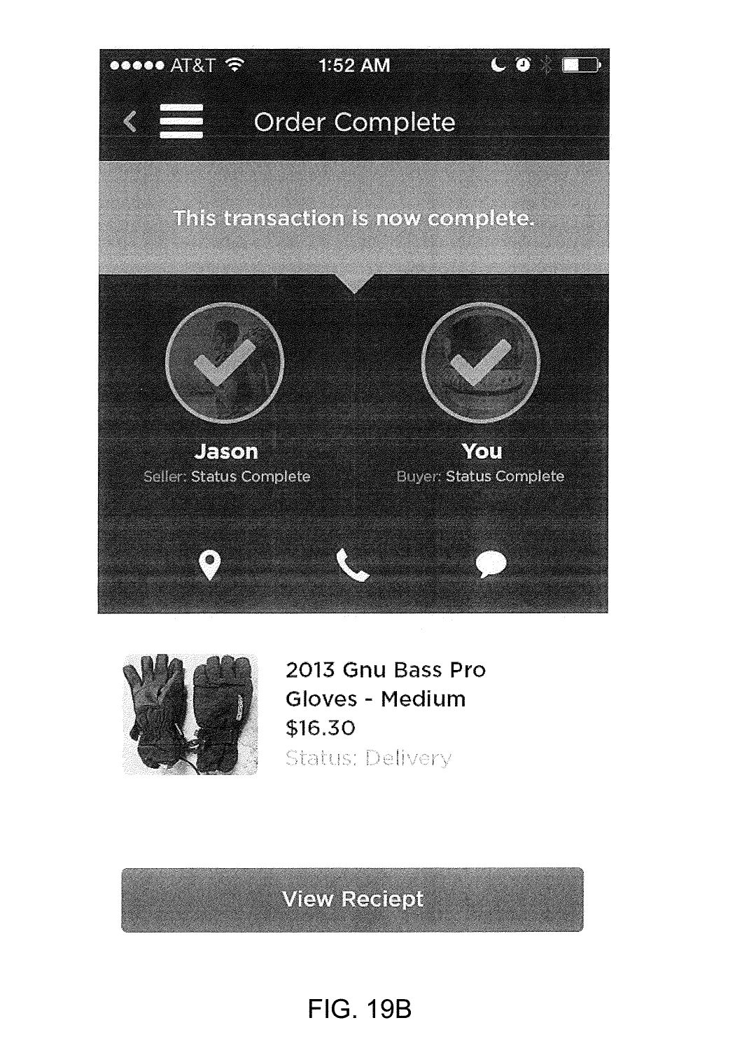

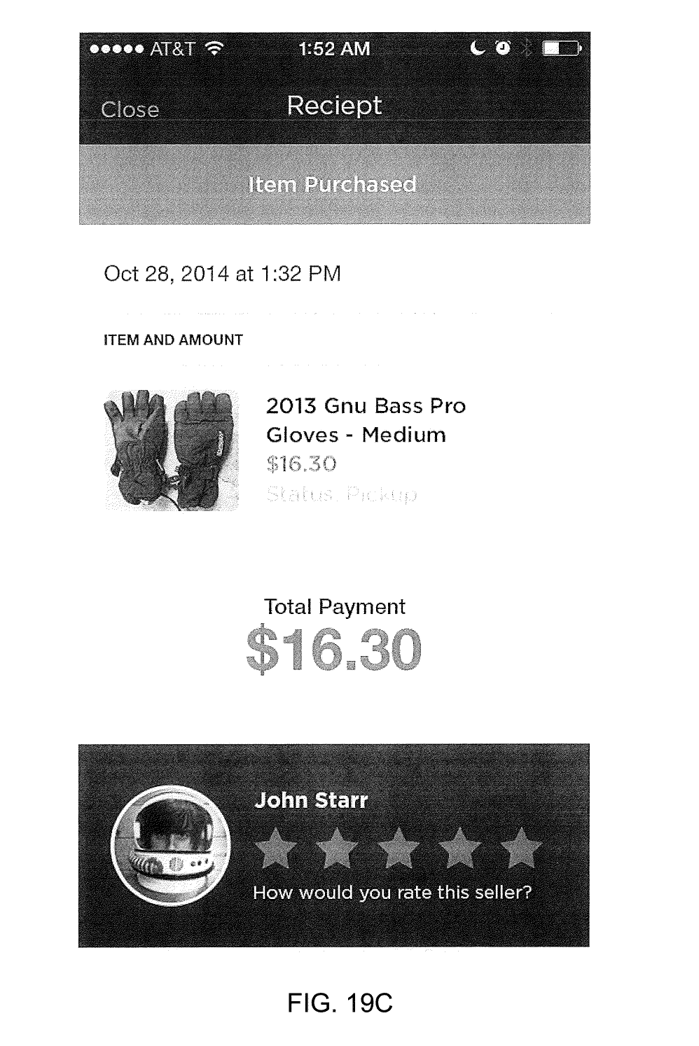

Referring to FIGS. 19A-C, the process is similarly displayed to the buyer and seller when the user is the buyer, as opposed to the seller. The buyer has the ability to rank or rate the seller, as shown in FIG. 19C, once the transaction is completed. This ranking ensures that both buyer and seller operate in good faith and treat one another fairly throughout the transaction.

Once the seller has accepted an offer and logistics of pick-up delivery have been executed through the application, the buyer can pay through the application. Alternatively, the buyer may elect to pay once the item is picked up. In varying embodiments, an authorized service provider permits transactions to occur through the application, and permitting verifiable identify, security, and safety to both the seller and buyer, with a variety of payment options. When the buyer completes a transaction, the funds may be placed in an escrow account. Those funds are then held in escrow until the transaction is complete. When the buyer and seller meet, or alternatively when the good is exchanged at a pre-arranged location, there is preferably a two-step authentication process occurs. In this authentication process, both the seller and the buyer confirm that the product has been provided, and that the buyer has picked up the product before the funds may be released to the seller.

The service provider may collect a small transaction fee for completing each transaction and a fee for providing the Dibs Drop. The funds transferred from a buyer to a seller may be managed by a third-party service, which would have access to the storefront and the mobile application in order to verify that the transaction has been completed and that escrowed funds may be released. With respect to delivering the released funds to the seller, the mobile application provides several options. First, a user may establish a relationship directly with their bank account, so the funds are released directly to a user's routing and account number. Second, the user can receive a physical check, money order, or other form of traditional payment. Third, the user may apply the funds as a credit towards their balance with the mobile application storefront and use that balance for creating featured advertisements or for purchasing goods themselves. In these scenarios, it is contemplated that the user will be charged a small transaction fee for each transaction, somewhere in the range of 2-3.5%.

According to preferred embodiments, the application provides several options for delivery. The seller can always deliver the goods to the person who bought it, and the buyer can always choose to pick up the goods from the location of the seller. Alternatively, the parties may send goods through the mail, Fed-Ex, or UPS. The user has the ability to make those arrangements and manage that delivery from the application's dashboard. Depending on the community, there may also be a fleet system of vehicles for local delivery. For local deliveries, the good will be delivered on the same day as the order, where possible.

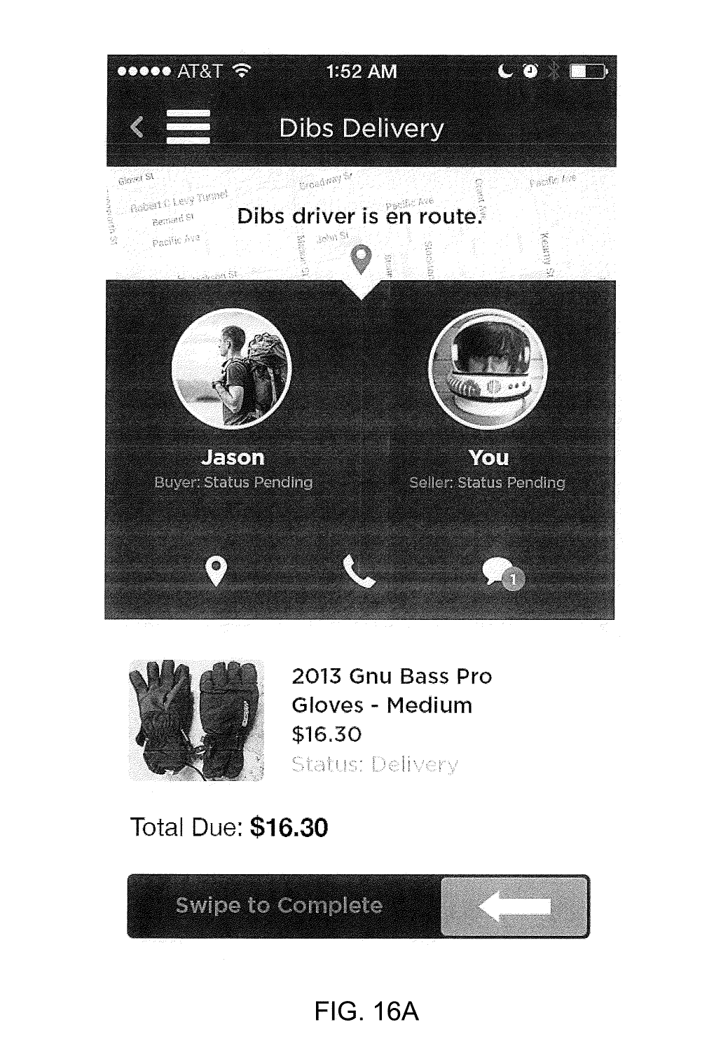

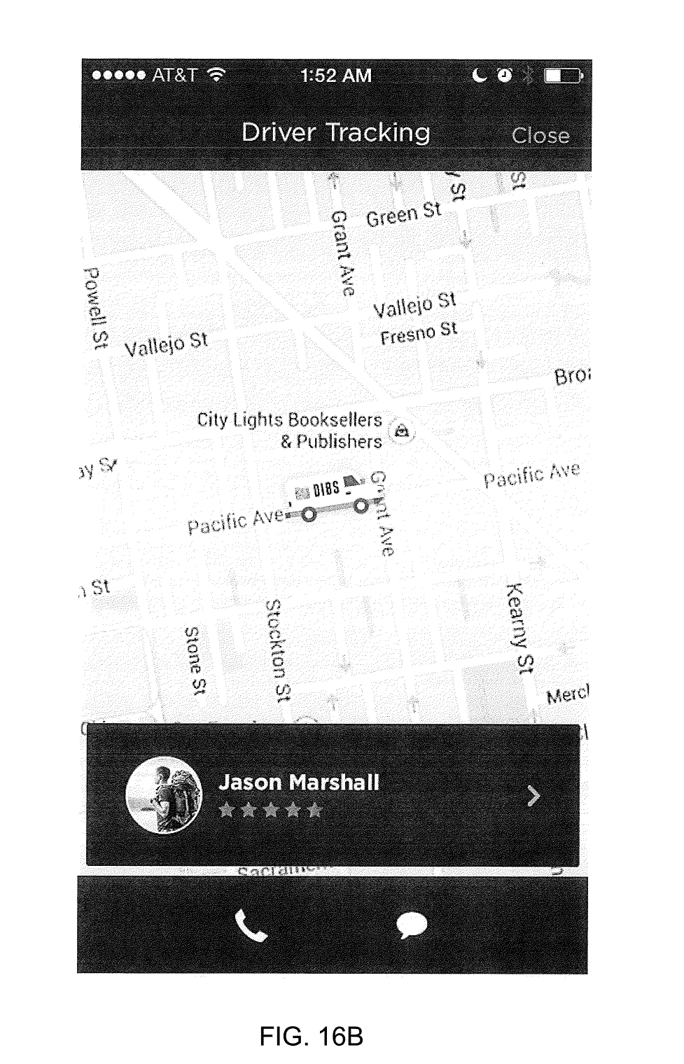

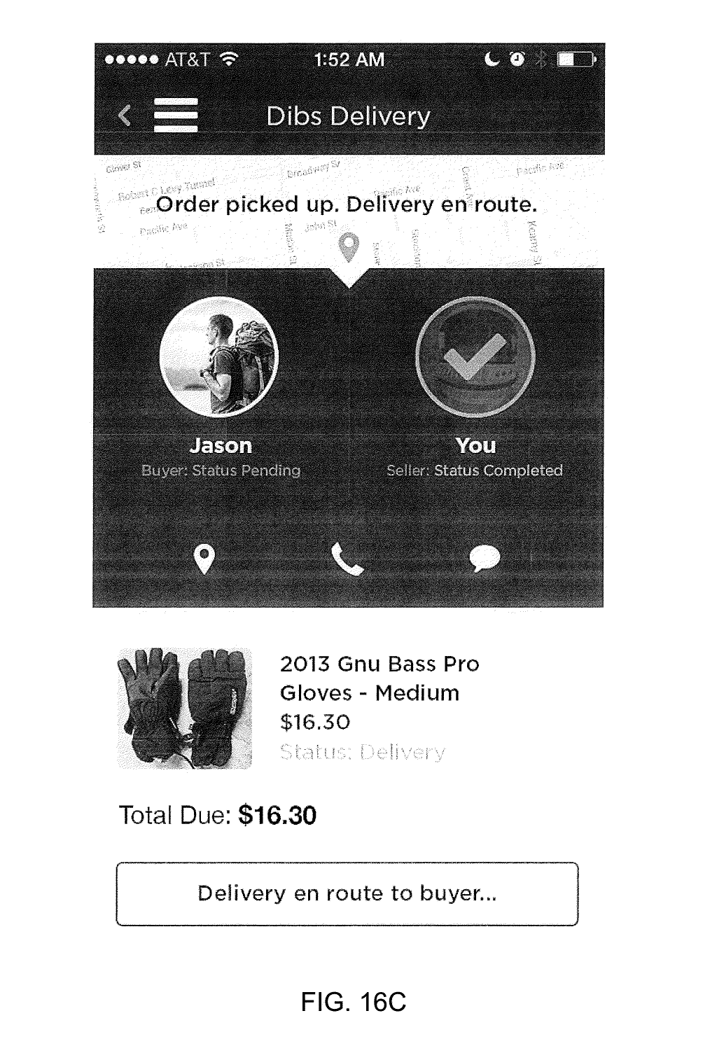

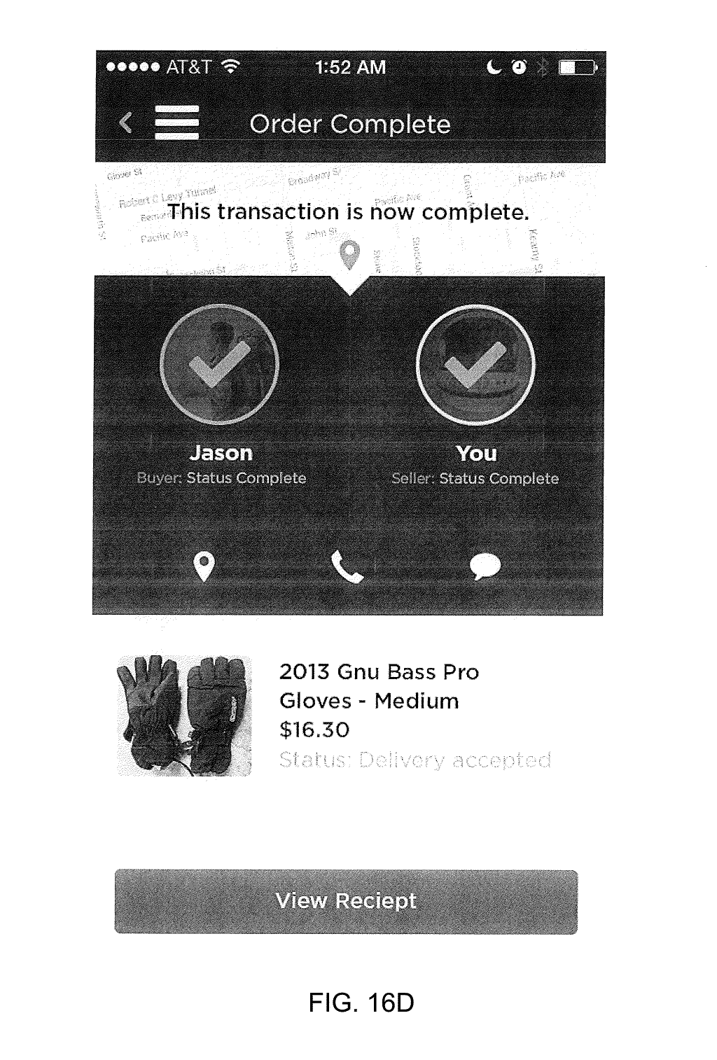

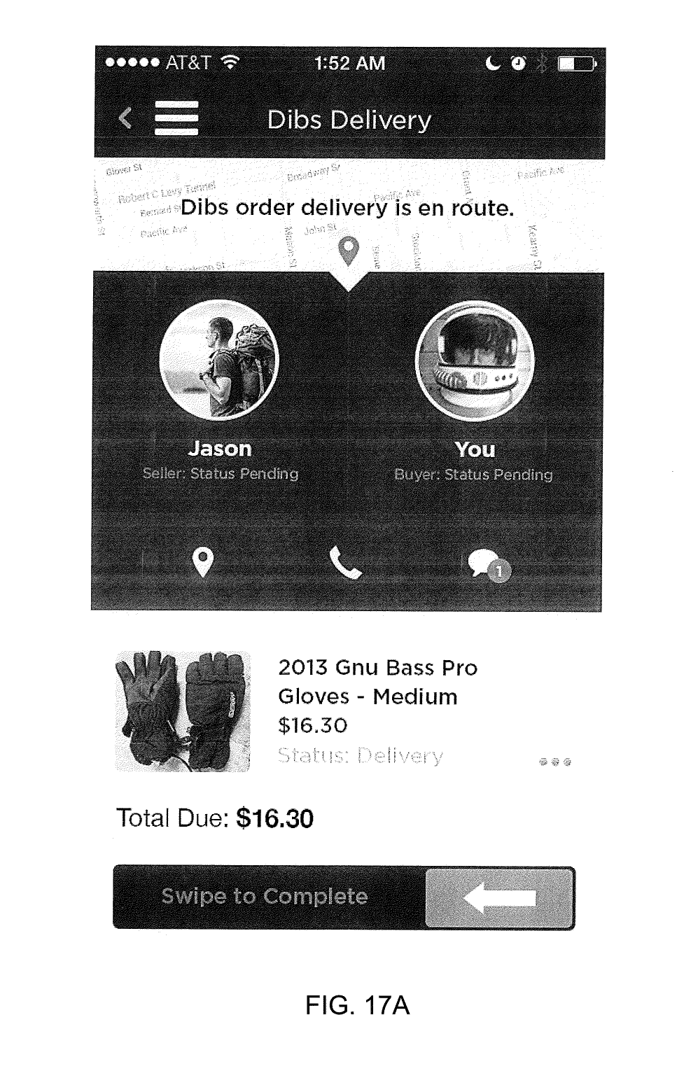

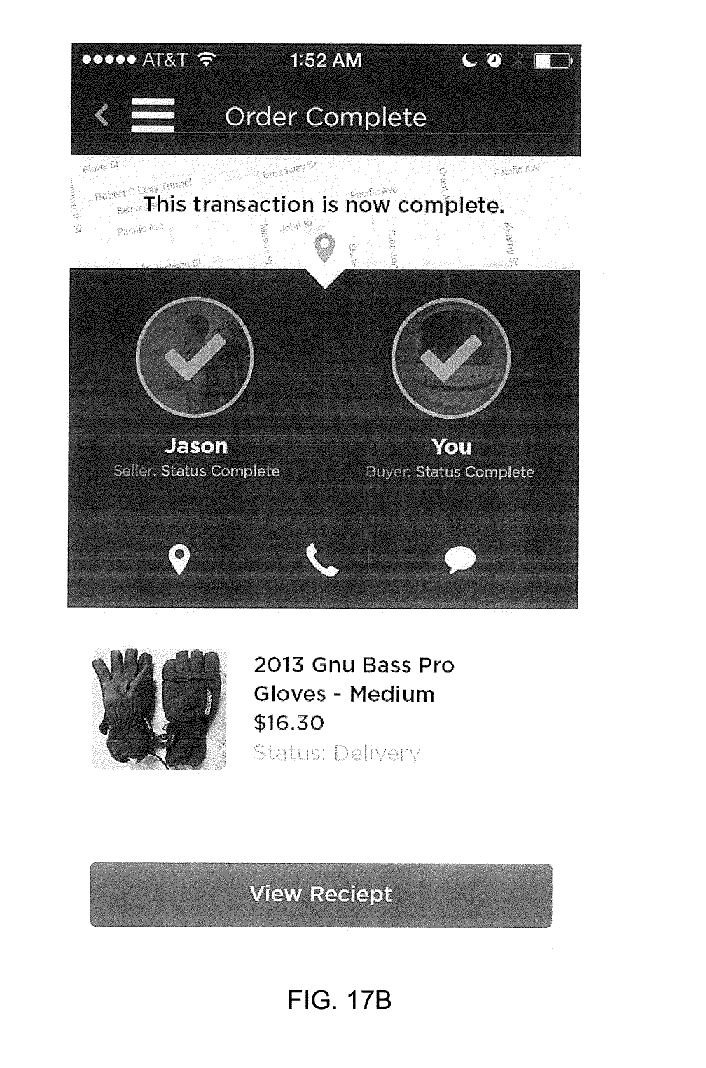

According to one embodiment, the user may set up delivery through the application as shown in FIGS. 16A-D. Here, the application shows that a Dibs Delivery service has been selected, and the good or item purchased is en route to the purchaser. The display may comprise a map and the location of the Dibs Delivery service, and may further comprise information or icons allowing the user to contact the driver or the buyer, or to receive messages from the driver or the buyer. Additional displays are shown in FIGS. 16B-D, which further show the status of the delivery and resulting transaction as completed between the seller and the buyer (i.e., once the good is delivered and inspected, and payment has been made and received). Similar displays may be provided when the user is in the position of the buyer, as opposed to the seller, as shown in FIGS. 17A-B.

In addition to having a fleet of vehicles, Dibs may also provide a central warehouse to store items, either for pick-up by a buyer or for delivery by a Dibs driver. The driver or mover can pick-up the item from the seller, they may immediately accept that item, they may be required to take pictures, they may be asked to contact the buyer before they accept that item and/or assist in confirming the purchase. Variations on this particular service are contemplated and within the scope of the present disclosure.

The seller can place whatever products they want to sell locally on the mobile application and can manage these items by way of a mobile dashboard or similar display provided within the mobile application. The seller may use mobile application features such as photos, video, etc. to enhance their listing. The seller may also place advertisements within the system, or feature specific items in particular categories. An example would be if the seller has an iPhone that he would like to sell, and the product is in good condition, the seller may have that iPhone featured in the electronics category of the mobile application.

Other tools allow the user to manage advertisements, manage transactions or pending sales, create new advertisements, upload video content, etc. The seller can operate their store and have access to data intelligence from the mobile application, such as what competing goods are being offered and at what prices, the content of other advertisements for similar products, viewing how much money they have made, when their advertisements are most viewed or are the most successful at leading to a transaction, obtain recommendations for optimizing their advertisements or storefront, etc.

The mobile application may have several categories of consumer goods. Those goods could be classified under headings such as baby/infant, automotive, music, television, etc. The mobile application may include further sub-classification, such as by supplier or color, for example. The user may select multiple locations. For example, even though you may be in Denver, Colo., the user can select to see products from Boulder, Fort Collins and Gunnison, Colo.. Proximity is not intended to be a limitation on the scope of potential transactions.

The mobile application may also provide helpful tips to the potential buyer, such as providing pricing information for a similar new or unused product of the same type, or alternatively by providing cross-reference to other storefronts such as Amazon.com. Over time the user may track their savings and also track trends from the data collected from the sale and purchase of different goods from the same or different sellers.

The preferences and habits of a particular user may be easily shared with others, including other non-users. For example, the wants of a particular buyer may be shared via Facebook, Twitter, e-mail, text, chat or via other social media services. Preferences and “likes” may be stored by the user during a particular session and accessed later, and is accessible from the user's saved list as well. The sharing is accessible through several locations, including a product detail page. The sharing is also accessible directly from the Dibs list.

The term “mobile device” or “mobile computer” as used herein refers to any hardware device and/or software operable to engage in a computing session. For example, a mobile device can be an IP-enabled computer, a tablet computer, a cellular phone, a personal digital assistant, a laptop computer system, etc. In embodiments, the mobile computer is a computer system as described in conjunction with FIGS. 31 and 32.

The term “network” as used herein refers to a system used by a communication platform to provide communications between mobile computers. The network can consist of one or more session managers, feature servers, mobile computers, etc. that allow communications, whether voice or data, between two users. A network can be any network or communication system as described in conjunction with FIGS. 31 and 32. Generally, a network can be a local area network (LAN), a wide area network (WAN), a wireless LAN, a wireless WAN, the Internet, etc. that receives and transmits messages or data between devices to facilitate communication platform activities. A network may communicate in any format or protocol known in the art, such as, transmission control protocol/interne protocol (TCP/IP), 3202.11g, 3202.11n, Bluetooth, or other formats or protocols.

The term “database,” “archive,” or “data structure” as used herein refers to any system, hardware, software, memory, storage device, firmware, component, etc., that stores data. The data model can be any type of database or storage framework described in conjunction with FIGS. 31 and 32, which is stored on any type of non-transitory, tangible computer readable medium. A database can include one or more data structures, which may comprise one or more sections or portions that store an item of data. A section may include, depending on the type of data structure, an attribute of an object, a data field, or other types of sections included in one or more types of data structures. The data structure can represent a text string or be a component of any type of database, for example, relational databases, flat file databases, object-oriented databases, or other types of databases. Further, the data structures can be stored in memory or memory structures that may be used in either run-time applications or in initializing a communication.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation or technique.

The term “identifier” and variations thereof, as used herein, refers to any numeric, alphanumeric, symbolic, globally unique identifier, or other identifier as understood in the art.

The term “module” refers to any known or later developed hardware, software, firmware, artificial intelligence, fuzzy logic, or combination of hardware and software that is capable of performing the functionality associated with that element. Also, while the various concepts are described in terms of exemplary embodiments, it should be appreciated that aspects can be separately claimed.

The terms “in communication” shall mean any electrical connection, whether wireless or wired, that allows two or more systems, components, modules, devices, etc. to exchange data, signals, or other information using any protocol or format.

The phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While various embodiment of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a tablet-like device, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, inventive aspects lie in less than all features of a single foregoing disclosed embodiment. Thus, the following claims are hereby incorporated into this Detailed Description, with each claim standing on its own as a separate preferred embodiment of the disclosure.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The present inventions, in various embodiments, include components, methods, processes, systems and/or apparatuses substantially as depicted and described herein, including various embodiments, subcombinations, and subsets thereof. Those of skill in the art will understand how to make and use the present inventions after understanding the present disclosure. The present inventions, in various embodiments, include providing devices and processes in the absence of items not depicted and/or described herein or in various embodiments hereof, including in the absence of such items as may have been used in previous devices or processes, e.g., for improving performance, achieving ease and\or reducing cost of implementation.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for facilitating an exchange of a good or service, the system comprising:
a server comprising:
a memory;
a processor in communication with the memory, the process operable to:
provide a configuration framework;
receive configuration changes associated with the framework;
provide the configuration changes;
receive data;
store the data;
sort the data;
distribute the data;
at least one user device in communication with the server, the at least one user device comprising:
a second memory;
a second processor in communication with the second memory, the processor operable to:
access the configuration framework associated with the server processor;
sort the data stored in the memory of the server processor;
display the data stored in the memory of the server processor;
initiate an order associated with at least one item contained within the data;
an ordering module that receives the order from the at least one user device; and
an authentication module that authenticates the form of payment associated with the order from the at least one user device and transfers payment to at least one other user device.
